(19) United States
(12) Patent Application Publication
(10) Pub. No.: US 2024/0206549 A1
(43) Pub. Date: Jun. 27, 2024

(54) ELECTRONIC ATOMIZATION DEVICE AND POWER SUPPLY APPARATUS THEREOF

(71) Applicant: SHENZHEN SMOORE TECHNOLOGY LIMITED, Shenzhen (CN)

(72) Inventors: Wenxiao XU, Shenzhen (CN); Xinyu WANG, Shenzhen (CN); Xiaowanyue HU, Shenzhen (CN); Hongtao SUN, Shenzhen (CN)

(21) Appl. No.: 18/598,395

(22) Filed: Mar. 7, 2024

Related U.S. Application Data
(63) Continuation of application No. PCT/CN2022/114611, filed on Aug. 24, 2022.

(30) Foreign Application Priority Data
Sep. 10, 2021 (CN) 202111064553.X

(51) Int. Cl. A24F 40/485; A24F 40/51; G10K 11/16

(52) U.S. Cl. CPC A24F 40/485; A24F 40/51; G10K 11/161

(57) ABSTRACT

A power supply apparatus includes: a housing provided with at least one air inlet hole and a noise reduction cavity; and a plurality of micropores enabling the at least one air inlet hole to communicate with the noise reduction cavity, the plurality of micropores being formed inside the housing. In an embodiment, a diameter of each micropore of the plurality of micropores ranges from 0.3 to 1 mm.

### CROSS-REFERENCE TO PRIOR APPLICATION

This application is a continuation of International Patent Application No. PCT/CN2022/114611, filed on Aug. 24, 2022, which claims priority to Chinese Patent Application No. 202111064553.X, filed on Sep. 10, 2021. The entire disclosure of both applications is hereby incorporated by reference herein.

### FIELD

The present invention relates to the field of atomization, and more specifically, to an electronic atomization device and a power supply apparatus.

### BACKGROUND

An electronic atomization device in the prior art mainly includes an atomizer and a power supply apparatus. The power supply apparatus is configured to supply power to the atomizer. After being powered on, the atomizer can heat and atomize a liquid atomization substrate stored therein to generate atomized vapor for a user to inhale. During inhalation, an inlet airway of the atomizer causes an inhalation noise problem because of airflows. The higher the inhalation speed, the higher the noise. Therefore, how to reduce inhalation noise and improve the user experience is a problem that urgently needs to be resolved.

### SUMMARY

In an embodiment, the present invention provides a power supply apparatus, comprising: a housing provided with at least one air inlet hole and a noise reduction cavity; and a plurality of micropores configured to enable the at least one air inlet hole to communicate with the noise reduction cavity, the plurality of micropores being formed inside the housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic three-dimensional structural diagram of an electronic atomization device in a first embodiment of the present invention;

FIG. 2 is a schematic exploded structural view of the electronic atomization device shown in FIG. 1;

FIG. 3 is a schematic longitudinal cross-sectional structural view of the electronic atomization device shown in FIG. 1;

FIG. 4 is a schematic exploded structural view of an atomizer in FIG. 2;

FIG. 5 is a schematic exploded structural view of a power supply apparatus in FIG. 2;

FIG. 6 is a schematic longitudinal cross-sectional structural view of a power supply apparatus in FIG. 2 when having a housing hidden;

FIG. 7 is a schematic transverse exploded structural view of a power supply apparatus in FIG. 2;

FIG. 8 is a diagram of noise distribution at the bottom of an atomizer;

FIG. 9 is a diagram of vibration streamline distribution at the bottom of an atomizer;

FIG. 10 is a schematic three-dimensional structural diagram of a power supply apparatus in a second embodiment of the present invention having a housing hidden;

FIG. 11 is a diagram of noise distribution at the bottom of an atomizer when an electronic atomization device uses the power supply apparatus shown in FIG. 10;

FIG. 12 is a diagram of vibration streamline distribution at the bottom of an atomizer when an electronic atomization device uses the power supply apparatus shown in FIG. 10;

FIG. 13 is a schematic three-dimensional structural diagram of a power supply apparatus in a third embodiment of the present invention having a housing hidden;

FIG. 14 is a diagram of noise distribution at the bottom of an atomizer when an electronic atomization device uses the power supply apparatus shown in FIG. 13; and

FIG. 15 is a diagram of vibration streamline distribution at the bottom of an atomizer when an electronic atomization device uses the power supply apparatus shown in FIG. 13.

### DETAILED DESCRIPTION

In an embodiment, the present invention provides an improved power supply apparatus and an electronic atomization device having the power supply apparatus, to overcome the foregoing defects in the prior art.

In an embodiment, the present invention provides a power supply apparatus, including a housing, where the housing is provided with at least one air inlet hole, and a noise reduction cavity and a plurality of micropores enabling the at least one air inlet hole to communicate with the noise reduction cavity are formed inside the housing.

In some embodiments, the diameter of the micropore ranges from 0.3 to 1 mm.

In some embodiments, the minimum cross-sectional area of the noise reduction cavity is greater than the total air inlet area of the plurality of micropores.

In some embodiments, the plurality of micropores include at least two first micropores and at least two second micropores respectively located on two opposite sides of the noise reduction cavity.

In some embodiments, the quantity of the first micropores is the same as or different from the quantity of the second micropores.

In some embodiments, the total air inlet area of the at least two first micropores is the same as the total air inlet area of the at least two second micropores.

In some embodiments, projections of the at least two first micropores and the at least two second micropores along the air inlet direction at least partially overlap.

In some embodiments, there are two air inlet holes, and the two air inlet holes are respectively arranged on two opposite sides of the housing.

In some embodiments, the first micropores and the second micropores are respectively located on the other two opposite sides of the housing.

In some embodiments, the two air inlet holes, the at least two first micropores, and the at least two second micropores are arranged in a staggered manner along the circumferential direction of the housing.

In some embodiments, the power supply apparatus further includes an airflow sensor arranged inside the housing, and a sensing channel enabling the airflow sensor to communicate with the noise reduction cavity is further formed inside the housing.

In some embodiments, the air inlet end of the sensing channel is located on the side of the noise reduction cavity in communication with the micropores.

In some embodiments, the air inlet end of the sensing channel extends into the noise reduction cavity, and an air inlet at the air inlet end of the sensing channel is located higher than the bottom surface of the noise reduction cavity.

In some embodiments, the power supply apparatus further includes a holder arranged inside the housing, the noise reduction cavity is formed through a downward depression of the top surface of the holder, and the plurality of micropores are respectively formed on two opposite sides of the holder.

In some embodiments, an air passage in communication with the at least one air inlet hole and the plurality of micropores is further formed inside the housing.

In some embodiments, the air passage is annular.

In some embodiments, the air passage is formed through an inward depression the outer surface of the holder, and the plurality of micropores is formed through an inward depression of the inner surface of the air passage.

In some embodiments, the power supply apparatus further includes a seal member sealingly arranged between the outer surface of the holder and the inner surface of the housing.

The present invention further provides an electronic atomization device, including the power supply apparatus of any one of the foregoing and an atomizer electrically connected to the power supply apparatus.

In some embodiments, an air guiding channel, an atomization cavity, and an air outlet channel that are sequentially in communication are formed inside the atomizer; and the air guiding channel is in communication with the noise reduction cavity.

### Beneficial Effects

Implementation of the present invention brings at least the following beneficial effects: Outside air enters through the air inlet hole and then flows into the micropores, to achieve a noise reduction effect using the high acoustic resistance characteristic of the micropores, thereby reducing the noise. Airflows flowing into the micropores then flow into the noise reduction for mixing, to reduce the flow velocity of the airflows, thereby further reducing the noise.

To provide a clearer understanding of the technical features, objectives, and effects of the present invention, specific implementations of the present invention are described in detail with reference to the accompanying drawings. In the following description, many specific details are described for thorough understanding of this specification. However, the present invention may be implemented in many other manners different from those described herein. A person skilled in the art may make similar improvements without departing from the connotation of the present invention. Therefore, the present invention is not limited to the specific embodiments disclosed below.

In the description of the present invention, it should be understood that, orientations or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “axial”, “radial”, and “circumferential” are orientations or position relationships shown based on the accompanying drawings or a usual orientation or a position relationship in which the product of the present invention is placed in use, and are merely used for describing the present invention and simplifying the description, rather than indicating or implying that the apparatus or element should have a particular orientation or be constructed and operated in a particular orientation, and therefore, should not be construed as a limitation to the present invention.

In addition, the terms “first” and “second” are used merely for the purpose of description, and shall not be construed as indicating or implying relative importance or implying a quantity of indicated technical features. Therefore, features defining “first” and “second” can explicitly or implicitly include at least one of the features. In the description of the present invention, “a plurality of” means at least two, such as two and three unless it is specifically defined otherwise.

In the present invention, unless explicitly specified or limited otherwise, the terms “mounted”, “connected”, “connection”, and “fixed” should be understood broadly, for example, which may be fixed connections, detachable connections or integral connections; or the connection may be a mechanical connection or an electrical connection; or the connection may be a direct connection, an indirect connection through an intermediary, or internal communication between two elements or mutual action relationship between two elements, unless otherwise specified explicitly. A person of ordinary skill in the art may understand the specific meanings of the foregoing terms in the present invention according to specific situations.

In the present invention, unless explicitly specified or limited otherwise, a first characteristic “on” or “under” a second characteristic may be the first characteristic in direct contact with the second characteristic, or the first characteristic in indirect contact with the second characteristic by using an intermediate medium. Moreover, the first feature “over”, “above” and “up” the second feature may be that the first feature is directly above or obliquely above the second feature, or simply indicates that a horizontal height of the first feature is higher than that of the second feature. The first feature “under”, “below” and “down” the second feature may be that the first feature is directly below or obliquely below the second feature, or simply indicates that a horizontal height of the first feature is less than that of the second feature.

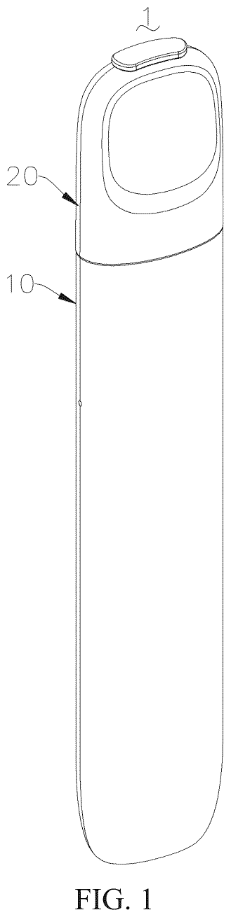

FIG. 1 shows an electronic atomization device 1 in a first embodiment of the present invention. The electronic atomization device 1 may be configured for inhaling an aerosol, may be in an elliptical columnar shape in some embodiments, and may include a power supply apparatus 10 and an atomizer 20 detachably arranged above the power supply apparatus 10 along the longitudinal direction. The atomizer 20 is configured to accommodate a liquid substrate and heat and atomize the liquid substrate to generate an aerosol. The power supply apparatus 10 is configured to supply power to the atomizer 20. It may be understood that the electronic atomization device 1 is not limited to the elliptical columnar shape, and may also be in another shape such as a cylinder shape, a square columnar shape, or a flat columnar shape, and the atomizer 20 and the power supply apparatus 10 may also be connected together in a non-detachable manner.

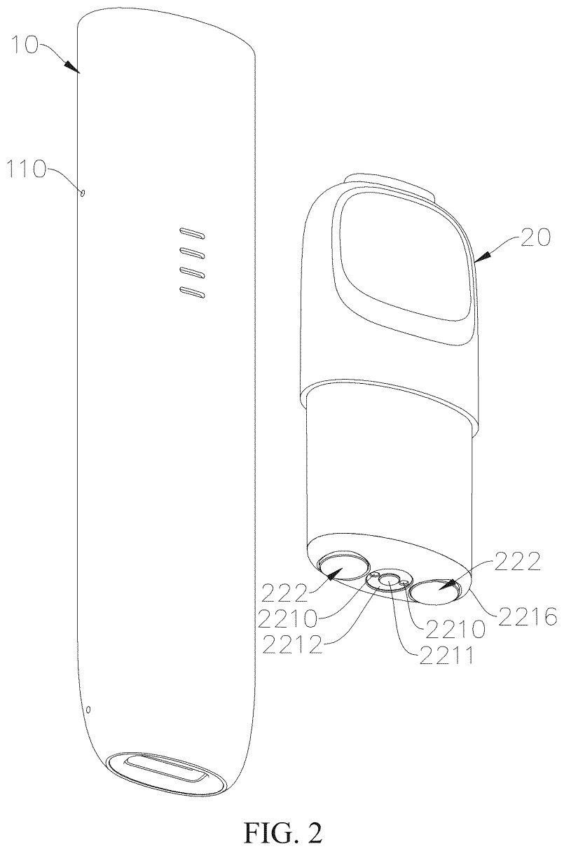

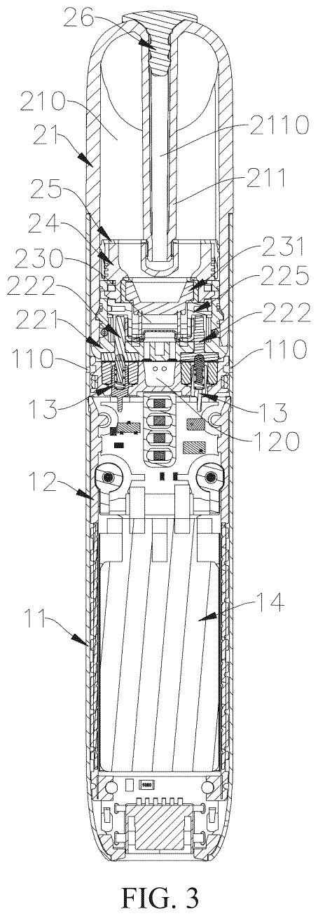

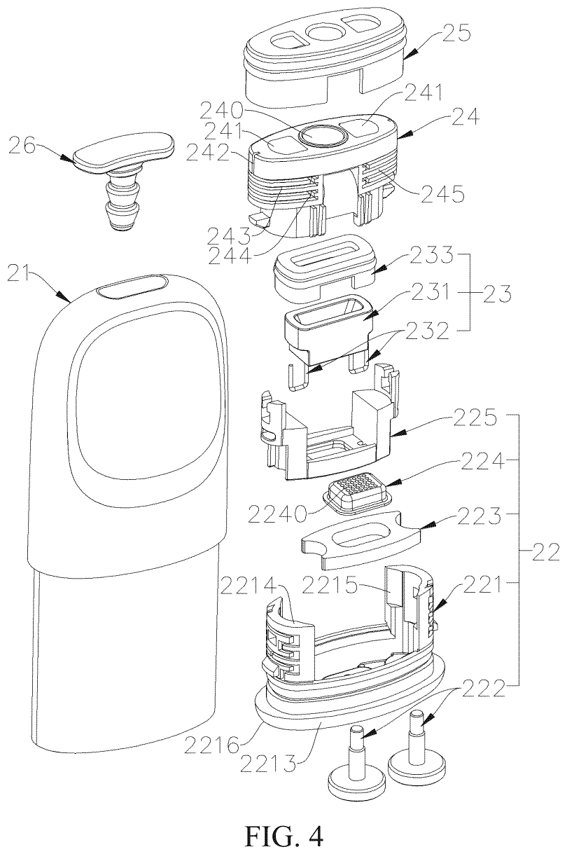

As shown in FIG. 2 and FIG. 3, the atomizer 20 may include a housing 21, a base component 22, a heating component 23, an atomization base 24, and an atomization sleeve 25 in some embodiments. The housing 21 is configured to accommodate the base component 22, the heating component 23, the atomization base 24 and the atomization sleeve 25, and a liquid storage cavity 210 configured to store a liquid substrate and an air outlet channel 2110 configured to output an aerosol may be formed in the housing 21.

The housing 21 may be roughly in an elliptical cylindrical shape. An air outlet pipe 211 is provided along the longitudinal direction inside the housing 21. The air outlet pipe 211 is connected to the inner side of the top wall of the housing 21 and may be coaxially arranged with the housing 21. An annular liquid storage cavity 210 is defined between the inner wall surface of the housing 21 and the outer wall surface of the air outlet pipe 211. The inner wall surface of the air outlet pipe 211 defines the air outlet channel 2110. In this embodiment, the air outlet pipe 211 and the housing 21 are integrally formed, for example, may be integrally formed by injection molding. In other embodiments, the air outlet pipe 211 and the housing 21 may also be formed separately and then assembled together.

The heating component 23 is accommodated in the space formed between the base component 22 and the atomization base 24, and in some embodiments, the heating component 23 may include a liquid absorption element 231 configured to absorb the liquid substrate from the liquid storage cavity 210, a heating element configured to heat and atomize, after being powered on and generating heat, the liquid substrate adsorbed in the liquid absorption element 231, two electrode leads 232 electrically connected to the heating element, and a seal sleeve 233 sleeved over the liquid absorption element 231. The liquid absorption element 231 in some embodiments may be a sintered porous body, and may be made of a hard capillary structure such as porous ceramic, porous glass ceramic, and porous glass. The liquid absorption element 231 is supported on the base component 22, and there is a specific gap between the bottom surface of the liquid absorption element 231 and the base component 22. This gap forms an atomization cavity 230, configured for mixing the aerosol and air. The seal sleeve 233 is sleeved over the upper part of the liquid absorption element 231 may be made of an elastic material such as silicone, and may play the role of carrying the liquid absorption element 231 and ensuring air tightness.

The atomization base 24 is sleeved over the heating component 23, and may be made of a plastic material. An air outlet hole 240 enabling the atomization cavity 230 to communicate with the air outlet channel 2110 and at least one liquid inlet hole 241 enabling the liquid storage cavity 210 to communicate with the liquid absorption element 231 in a liquid guiding manner are formed on the atomization base 24. In this embodiment, the air outlet hole 240 may be formed by extending downward from the middle part of the top surface of the atomization base 24, and the lower end of the air outlet pipe 211 may be inserted into the air outlet hole 240. There are two liquid inlet holes 241 that may be formed by extending downward from the top surface of the atomization base 24. The two liquid inlet holes 241 may be respectively located on the two sides of the air outlet hole 240 along the length direction.

In some embodiments, at least one vent channel 245 may also be formed on the atomization base 24, and the at least one vent channel 245 is in communication with the outside and the liquid storage cavity 210. When the air pressure inside the liquid storage cavity 210 is too low, outside air may enter the liquid storage cavity 210 through the vent channel 245, to raise the air pressure in the liquid storage cavity 210, to avoid that the liquid does not flow smoothly because the air pressure in the liquid storage cavity 210 is too low and prevent dry burning. In this embodiment, there are two vent channels 245, and the two vent channels 245 are respectively formed on the two sides of the atomization base 24 along the length direction. Each vent channel 245 includes a first vent groove 242 extending longitudinally and a second vent groove 243 extending circumferentially. The first vent groove 242 may extend longitudinally downward from the outer side of the top of the atomization base 24 to communicate with the second vent groove 243. The second vent groove 243 may be formed through an inward depression of the outer circumferential surface of the atomization base 24. There may be a plurality of second vent grooves 243, and the plurality of second vent grooves 243 may be spaced apart in parallel. The vent channel 245 may further include a third vent groove 244 enable the plurality of second vent grooves 243 to communicate with each other. The first vent groove 242, the second vent groove 243, and the third vent groove 244 may all be formed by thin grooves, to prevent the vent channel 245 from forming an obstacle to the flow of the air, but the vent channel 245 can form an obstacle to the flow of the liquid substrate, to ensure that the vent channel 245 has the functions of ventilation and liquid resistance, thereby reducing the possibility that the atomization substrate in the liquid storage cavity 210 leaks through the vent channel 245. In addition, the vent channel 245 further has a specific liquid storage function and can store a specific amount of condensate. Preferably, the first vent groove 242, the second vent groove 243, and the third vent groove 244 may all be formed by capillary grooves that can generate a capillary force. Through the capillary force, the liquid is automatically guided, for the condensate in the vent channel 245 to flow back to the liquid storage cavity 210. In some embodiments, the cross-sectional area range of the first vent groove 242, the second vent groove 243, and the third vent groove 244 may be less than or equal to 1 mm², preferably, less than or equal to 0.1 mm².

The atomization sleeve 25 is sleeved over the atomization base 24, may be made of an elastic material such as silicone, and is configured to seal the liquid storage cavity 210, to prevent the liquid substrate in the liquid storage cavity 210 from leaking through the outer circumferential surface of the atomization base 24, and prevent the liquid substrate in the liquid storage cavity 210 from leaking into the air outlet channel 2110.

The base component 22 may include a base 22, an electrode post 222, a liquid absorbing sponge 223, a diversion network 224, and a limiting member 225 in some embodiments.

The base 221 is embedded at a lower-end opening of the housing 21 and may be snap-connected to the housing 21. The base 221 may include a base body 2213, a first support arm 2214 erected on the top surface of the base body 2213, and a second support arm 2215 erected on the top surface of base body 2213 and arranged opposite to the first support arm 2214. The liquid absorption element 231 is supported between the first support arm 2214 and the second support arm 2215. The base body 2213 may be roughly in a shape of an elliptical thin plate, and the atomizer 20 may be supported on the holder 12 of the power supply apparatus 10 through the base body 2213. The base body 2213 has a matching surface 2216 that is in contact with and that matches the holder 12. In this embodiment, the matching surface 2216 is formed by the outer circumferential surface of the bottom of base body 2213 and may be in an arc shape. At least one air guide hole 2210 enabling the atomization cavity 230 to communicate with the outside may be longitudinally formed on the base body 2213. In this embodiment, there are two air guide holes 2210. A circular annular airflow groove 2212 may be formed through an upward depression in the middle part of the bottom surface of the base body 2213. A protruding portion 2211 is formed in the middle part of the airflow groove 2212. The two air guide holes 2210 may be formed by extending upward from the groove bottom surface of the airflow groove 2212, and may be respectively located on the two radial sides of the protruding portion 2211.

The electrode post 222 may be longitudinally arranged on the base body 2213 in a penetrating manner. There may be two electrode posts 222, and the two electrode posts 222 are electrically connected to the two electrode leads 232 respectively. The two electrode posts 222, the two air guide holes 2210, and the protruding portion 2211 may be located in the length direction of the base body 2213.

The liquid absorbing sponge 223 is arranged on the base body 2213 and is configured to absorb the condensate stored in the base body 2213, to further prevent leakage of the condensate, thereby avoiding impact of liquid leakage on the performance of the power supply apparatus 10, and improving the user experience.

The diversion network 224 may be arranged on the liquid absorbing sponge 223 and may be made of a metal material such as stainless steel. A plurality of meshes 2240 are distributed on the diversion network 224. The plurality of meshes 2240 are located between the liquid absorption element 231 and the base body 2213, to enable the atomization cavity 230 to communicate with the two air guide holes 2210. The airflow groove 2212, the air guide holes 2210, and the mesh holes 2240 are in communication in sequence from bottom to top, to form an air guiding channel for the outside air to flow into the atomization cavity 230. Due to the small pore sizes of the meshes 2240, the liquid substrate may form a liquid film on each mesh 2240, thereby preventing the liquid substrate from leaking out. In addition, even if a part of the liquid substrate leaks from the diversion network 224, the part of the liquid substrate may also flow to the liquid absorbing sponge 223 and be absorbed by the liquid absorbing sponge 223.

The limiting member 225 is accommodated between the first support arm 2214 and the second support arm 2215, may be made of an elastic material such as silicone, and is configured to press and fix the diversion network 224 and the liquid absorbing sponge 223 onto the base body 2213.

The atomizer 20 may further include a mouthpiece plug 26 detachably arranged at the air outlet of the air outlet channel 2110 in some embodiments. The mouthpiece plug 26 may be made of an elastic material such as silicone, and is detachably plugged at the air outlet of the air outlet channel 2110. When the atomizer 20 is not in use, the mouthpiece plug 26 may be inserted to seal and block the upper-end air outlet of the air outlet channel 2110, to prevent foreign matter from entering the atomizer 20 and prevent the liquid substrate from leaking from the air outlet. For a use need, the mouthpiece plug 26 only needs to be pulled out.

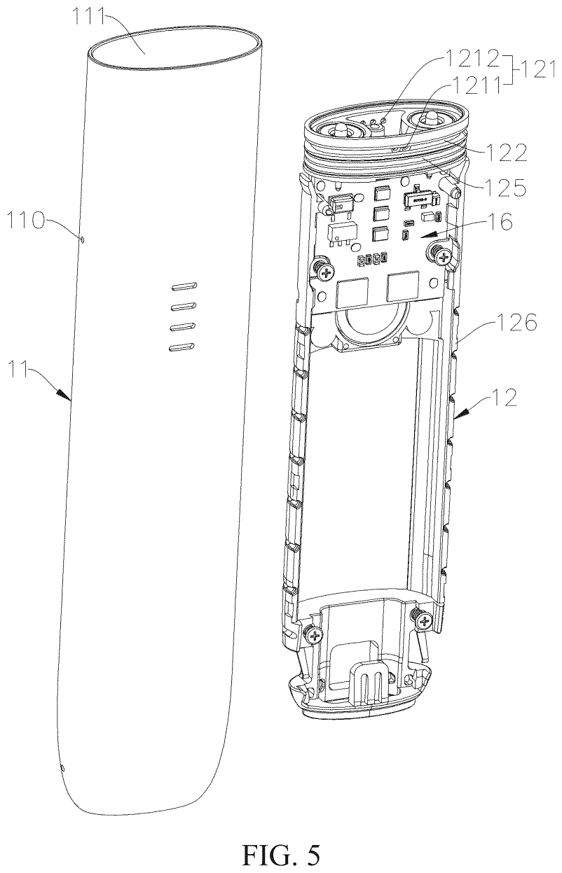

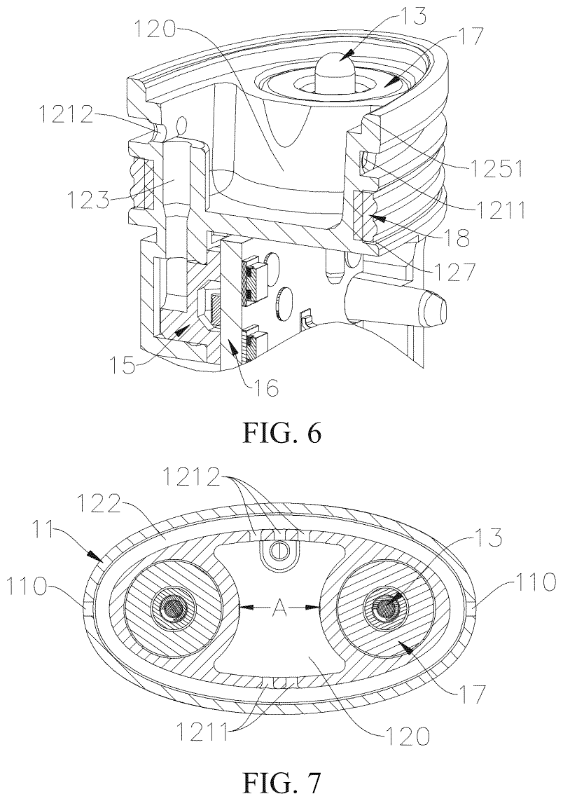

As shown in FIG. 3 and FIG. 5 to FIG. 7, in some embodiments, the power supply apparatus 10 may include a housing 11 and a holder 12, an elastic electrode 13, a battery 14, an airflow sensor 15 and a circuit board 16 accommodated in the housing 11. The elastic electrode 13, the battery 14, and the airflow sensor 15 are electrically connected to the circuit board 16 respectively. During inhalation performed by a user, the airflow sensor 15 senses an airflow flowing through it, and the circuit board 16 controls the battery 14 to supply power to the heating component 23 of the atomizer 20.

The housing 11 may be roughly in an elliptical cylindrical shape, and an accommodating cavity 111 configured to accommodate the atomizer 20 is formed at the upper part of the housing 11. The holder 12 may be accommodated at the lower part of the housing 11, and may include a support portion 125 located at the upper portion and a main body portion 126 located at the lower portion. The battery 14, the airflow sensor 15, and the circuit board 16 may all be mounted on the main body portion 126. The battery 14 may be mounted at the lower part of the main body portion 126, and the airflow sensor 15 and the circuit board 16 may be mounted at the upper part of the main body portion 126. The elastic electrode 13 can be inserted into the support portion 125. Usually, there are two elastic electrodes 13. When the atomizer 20 is inserted into the accommodating cavity 111 and supported on the support portion 125, the two elastic electrodes 13 are in contact with the two electrode post 222 respectively for conduction. In some embodiments, the power supply apparatus 10 may further include a magnetic piece 17 embedded on the support portion 125, configured to be magnetically connected to the atomizer 20. In this embodiment, there are two magnetic pieces 17. The two magnetic pieces 17 may circular annular and are respectively sleeved over the two elastic electrodes 13.

At least one air inlet hole 110 in communication with the outside is formed on the housing 11, and an air passage 122, a micropore 121, and a noise reduction cavity 120 that are in communication with the at least one air inlet hole 110 are formed in sequence in the housing 11. The air inlet hole 110, the air passage 122, the micropore 121, and the noise reduction cavity 120 are in communication in sequence, to form an air inlet channel for the outside air to flow into the atomizer 20. After the outside air enters through the air inlet hole 110, the outside air flows into the micropore 121 through the air passage 122, flows into the air guide hole 2210 after being mixed in the noise reduction cavity 120, and then flows into the atomization cavity 230. Due to the small pore size and the air inlet area of the micropore 121, for example, the pore size smaller than 1 mm, the high acoustic resistance characteristic of the micropore 121 is utilized to achieve the noise reduction effect, thereby reducing the noise.

In this embodiment, there are two air inlet holes 110 and may be respectively formed on the side walls of the housing 11 on the two sides along the length direction. The air passage 122 is a surrounding airflow channel, and can reduce noise of the airflow. Specifically, the air passage 122 may be formed through an inward depression of the outer circumferential surface of the support portion 125. There are a plurality of micropores 121. The diameter range of each micropore 121 may be between 0.3 and 1.0 mm, to achieve a better noise reduction effect while ensuring smooth air intake. The plurality of micropores 121 may extend transversely and be formed on the support portion 125, and may be formed through an inward depression of the inner surface of the air passage 122.

In some embodiments, the plurality of micropores 121 may include at least one first micropore 1211 and at least one second micropore 1212 that are formed on two opposite sides of support portion 125 respectively. The first micropore 1211, the second micropore 1212, and the air inlet hole 110 may be arranged in a staggered manner along the circumferential direction of the housing 11. Preferably, there may be a plurality of first micropores 1211 and a plurality of second micropores 1212 respectively, and the quantity of the first micropores 1211 may be the same as or different from the quantity of the second micropores 1212. Further, the total air inlet area of the plurality of first micropores 1211 is the same as the total air inlet area of the second micropores 1212, which is beneficial to reducing the noise. In this embodiment, there are two first micropores 1211 and three second micropores 1212. The first micropores 1211 and the second micropores 1212 are respectively formed on the two sides of the holder 12 along the width direction. Further, projections of the two first micropores 1211 and the three second micropores 1212 along the transverse direction, that is, the air inlet direction, at least partially overlap, which can further improve the noise reduction effect.

The noise reduction cavity 120 may be formed through a downward depression of the top surface of the support portion 125, and the central axis of the noise reduction cavity 120 may coincide with the central axis of the support portion 125. Two airflows that enter the noise reduction cavity 120 through the first micropores 1211 and the second micropores 1212 are mixed in the noise reduction cavity 120, which can reduce the flow velocity of the airflow, thereby further reducing the noise. The larger the volume of the noise reduction cavity 120, the better the noise reduction effect. Preferably, provided that the minimum cross-sectional area A in the noise reduction cavity 120 is guaranteed to be larger than the total air inlet area of the plurality of micropores 121, the flow velocity of the airflow can be reduced, to achieve the noise reduction effect. In this embodiment, the cross-section of the noise reduction cavity 120 is in a shape of an arc-shaped surface with large ends and a small center. The minimum cross-sectional area A of the noise reduction cavity 120 is located in the middle of its cross-section. The size of the middle cross-section of the noise reduction cavity 120 is small, to help leave enough mounting space for the magnetic pieces 17 and the elastic electrodes 13 on two sides of the middle cross-section of the noise reduction cavity 120.

A sensing channel 123 is also formed in the housing 11 to enable the air inlet channel to communicate with the airflow sensor 15. In this embodiment, the air inlet end of the sensing channel 123 may extend into the noise reduction cavity 120 and communicate with the noise reduction cavity 120. The air inlet of the air inlet end of the sensing channel 123 is located higher than the bottom surface of the noise reduction cavity 120. In this way, even if leakage liquid enters the noise reduction cavity 120, the leakage liquid can be prevented from further flowing to the airflow sensor 15, the circuit board 16, and the battery 14 through the sensing channel 123, thereby further improving the anti-leakage effect. Preferably, the air inlet end of the sensing channel 123 may be located on the side of the noise reduction cavity 120 in communication with the micropore 121, and the air inlet of the sensing channel 123 may be arranged close to the micropore 121, thereby ensuring the working sensitivity of the airflow sensor 15. Specifically, in this embodiment, the air inlet of the sensing channel 123 is arranged close to the second micropore 1212. The position of the air inlet of the sensing channel 123 may be flush with the bottom surface of the second micropore 1212 or slightly lower than the bottom surface of the second micropore 1212.

In addition, the support portion 125 has a contact surface 1251 that is in contact with the matching surface 2216 at the bottom of the atomizer 20. The contact surface 1251 matches the matching surface 2216 in shape, thereby increasing the sealing and reducing airflows leaking from the gap between the contact surface 1251 and the matching surface 2216, thereby reducing the noise. In this embodiment, the contact surface 1251 is formed on the inner circumferential surface of the upper end of the support portion 125, and the contact surface 1251 and the matching surface 2216 match each other in shape and are both arc-shaped.

In some embodiments, the power supply apparatus 10 may further include a seal member 18 sealingly arranged between the outer surface of the support portion 125 and the inner surface of the housing 11. The seal member 18 may be made of an elastic material such as silicone, and may be made into an annular shape and sleeved over the support portion 125. The outer surface of the seal member 18 may be in interference fit with the inner surface of the housing 11, and the sealing effect of the seal member 18 may be improved through the interference fit. A sealing groove 127 for the seal member 18 to fit in is formed through an inward depression of the outer circumferential surface of the support portion 125. The sealing groove 127 may be located below the air passage 122 and arranged close to the air passage 122. By arranging the seal member 18, the airflow entering the air passage 122 through the air inlet hole 110 may be prevented from leaking to below the seal member 18, thereby further reducing the noise. It may be understood that in another embodiment, the seal member 18 may also be arranged above the air passage 122 and may be arranged close to the air passage 122. Alternatively, in other embodiments, the seal member 18 may be arranged both above and below the air passage 122.

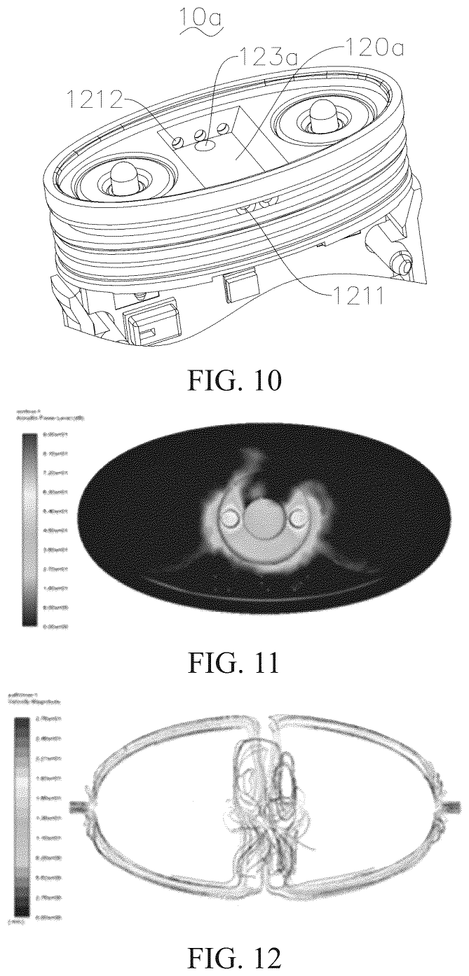

FIG. 10 shows a power supply apparatus 10a in a second embodiment of the present invention. The power supply apparatus 10a mainly differs from the first embodiment in that a noise reduction cavity 120a in this embodiment is a small noise reduction cavity, and its volume is less than that of the noise reduction cavity 120 in the first embodiment. Specifically, the cross-sectional shape of the noise reduction cavity 120a in this embodiment is rectangular, and the cross-sectional area of the width direction cross-section of the noise reduction cavity 120a is approximately the same as the minimum cross-sectional area A of the noise reduction cavity 120. In addition, the depth of the noise reduction cavity 120a is less than the depth of the noise reduction cavity 120, and the bottom surface of the noise reduction cavity 120a is flush with the location of the air inlet of the sensing channel 123a.

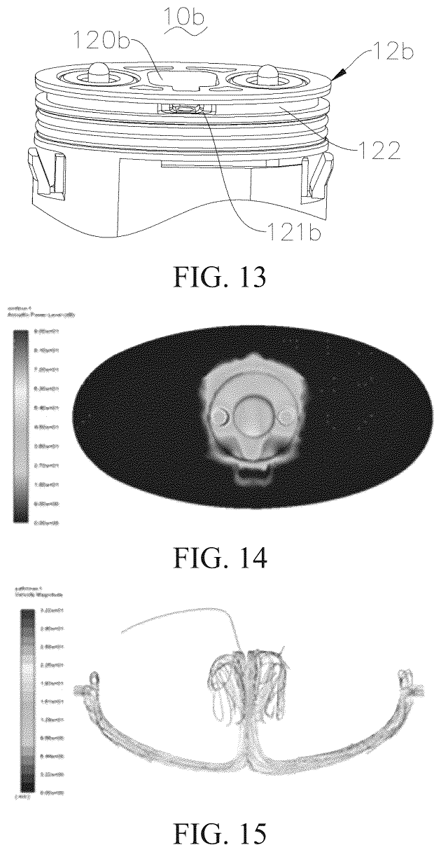

FIG. 13 shows a power supply apparatus 10b in a third embodiment of the present invention. The power supply apparatus 10b mainly differs from the first embodiment in that a holder 12b in this embodiment is provided with only a macropore 121b on the side wall on a single side, and the airflow flowing into the air passage 122 flows into a noise reduction cavity 120b through the macropore 121b. The macropore 121b has a larger air inlet area than that of the micropore 121. Specifically, in this embodiment, the macropore 121b is a rectangular hole.

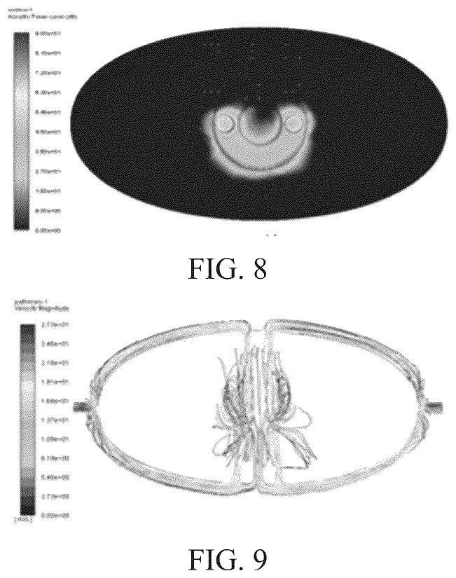

FIG. 8, FIG. 11, and FIG. 14 show diagrams of noise distribution at the bottom of the atomizer when the electronic atomization device uses the power supply apparatus 10, the power supply apparatus 10a, and the power supply apparatus 10b respectively. It can be seen from the diagrams of noise distribution that when the power supply apparatus 10 is used, the noise at the bottom of the atomizer is the lowest, and when the power supply apparatus 10b is used, the noise at the bottom of the atomizer is the highest. In addition, when the power supply apparatus 10 is used, the region corresponding to the protruding portion 2211 at the bottom of the atomizer is a flow retaining region, on which the flow velocity is almost zero, and has almost no impact on noise. When power supply apparatus 10 and power supply apparatus 10a are used, because the quantities of holes on two sides of the noise reduction cavity are unevenly distributed, the noise is higher on the side of the airflow groove 2212 at the bottom of the atomizer corresponding to the two first micropores 1211. The noise may be further reduced by distributing the quantities of micropores on two sides of the noise reduction cavity evenly. Alternatively, the pore size of the three second micropores 1212 may also be reduced (in consideration of the inhalation resistance, the pore size of the two first micropores 1211 may also be increased), to make the total air inlet area of the three second micropores 1212 equal to the total air inlet area of the two first micropores 1211 on the opposite side, thereby further reducing the noise.

FIG. 9, FIG. 12, and FIG. 15 show diagrams of vibration streamline distribution at the bottom of the atomizer when the electronic atomization device uses the power supply apparatus 10, the power supply apparatus 10a, and the power supply apparatus 10b respectively. It can be seen from the diagrams of streamline distribution that the single-side macropore air inlet structure of the power supply apparatus 10b causes the thin plate structure at the bottom of the atomizer to vibrate more severely, making it easier to generate noise.

It may be understood that the foregoing technical features can be used in any combination without restriction.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and

C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A power supply apparatus, comprising:
a housing provided with at least one air inlet hole and a noise reduction cavity; and
a plurality of micropores configured to enable the at least one air inlet hole to communicate with the noise reduction cavity, the plurality of micropores being formed inside the housing.

2. The power supply apparatus of claim 1, wherein a diameter of each micropore of the plurality of micropores ranges from 0.3 to 1 mm.

3. The power supply apparatus of claim 1, wherein a minimum cross-sectional area of the noise reduction cavity is greater than a total air inlet area of the plurality of micropores.

4. The power supply apparatus of claim 1, wherein the plurality of micropores comprise at least two first micropores and at least two second micropores respectively located on two opposite sides of the noise reduction cavity.

5. The power supply apparatus of claim 4, wherein a quantity of the at least two first micropores is equal to or different from a quantity of the at least two second micropores.

6. The power supply apparatus of claim 4, wherein a total air inlet area of the at least two first micropores is equal to a total air inlet area of the at least two second micropores.

7. The power supply apparatus of claim 4, wherein projections of the at least two first micropores and the at least two second micropores along an air inlet direction at least partially overlap.

8. The power supply apparatus of claim 4, wherein the at least one air inlet hole comprises two air inlet holes, and
wherein the two air inlet holes are respectively arranged on two opposite sides of the housing.

9. The power supply apparatus of claim 8, wherein the at least two first micropores and the at least two second micropores are respectively located on the other two opposite sides of the housing.

10. The power supply apparatus of claim 8, wherein the two air inlet holes, the at least two first micropores, and the at least two second micropores are arranged in a staggered manner along a circumferential direction of the housing.

11. The power supply apparatus of claim 1, further comprising:
an airflow sensor arranged inside the housing; and
a sensing channel configured to enable the airflow sensor to communicate with the noise reduction cavity, the sensing channel being formed inside the housing.

12. The power supply apparatus of claim 11, wherein an air inlet end of the sensing channel is located on a side of the noise reduction cavity in communication with the plurality of micropores.

13. The power supply apparatus of claim 11, wherein an air inlet end of the sensing channel extends into the noise reduction cavity, and
wherein an air inlet at the air inlet end of the sensing channel is located higher than a bottom surface of the noise reduction cavity.

14. The power supply apparatus of claim 1, further comprising:
a holder arranged inside the housing,
wherein the noise reduction cavity is formed through a downward depression of a top surface of the holder, and
wherein the plurality of micropores are respectively formed on two opposite sides of the holder.

15. The power supply apparatus of claim 14, wherein an air passage in communication with the at least one air inlet hole and the plurality of micropores is formed inside the housing.

16. The power supply apparatus of claim 15, wherein the air passage is annular.

17. The power supply apparatus of claim 15, wherein the air passage is formed through an inward depression of an outer surface of the holder, and
wherein the plurality of micropores is formed through an inward depression of an inner surface of the air passage.

18. The power supply apparatus of claim 14, further comprising:
a seal member sealingly arranged between an outer surface of the holder and an inner surface of the housing.

19. An electronic atomization device, comprising:
the power supply apparatus of claim 1; and
an atomizer electrically connected to the power supply apparatus.

20. The electronic atomization device of claim 19, wherein an air guiding channel, an atomization cavity, and an air outlet channel that are sequentially in communication are formed inside the atomizer, and
wherein the air guiding channel is in communication with the noise reduction cavity.
